(19) United States
(12) Patent Application Publication
(10) Pub. No.: US 2023/0008142 A1
(43) Pub. Date: Jan. 12, 2023

(54) TRANSLATION SUPPORT DEVICE THAT GENERATES UNTRANSLATED PORTION INFORMATION INDICATING UNTRANSLATED PORTION IN TRANSLATED DOCUMENT, AND IMAGE FORMING APPARATUS

(71) Applicant: KYOCERA Document Solutions Inc., Osaka (JP)

(72) Inventors: Imee BALDERAS, Osaka (JP); Cherry Belle CALLELERO, Osaka (JP)

(73) Assignee: KYOCERA Document Solutions Inc., Osaka (JP)

(21) Appl. No.: 17/861,717

(22) Filed: Jul. 11, 2022

(30) Foreign Application Priority Data
Jul. 12, 2021 (JP) 2021-115232

(51) Int. Cl. G06F 40/58; G06V 30/10; G06F 40/274

(52) U.S. Cl. CPC G06F 40/58; G06V 30/10; G06F 40/274

(57) ABSTRACT

A translation support device includes a storage device and a control device. The storage device stores therein an original document file in which original document data is recorded, and a translated document file in which translated document data, representing a translated document translated from an original document represented by the original document data, is recorded. The control device includes a processor, and acts as a detector and a generator, when the processor executes a control program. The detector detects, through comparison between the original document file and the translated document file, a same portion contained in common in both of the files, as an untranslated portion. The generator generates untranslated portion information indicating the untranslated portion.

### INCORPORATION BY REFERENCE

This application claims priority to Japanese Patent Application No.2021-115232 filed on Jul. 12, 2021, the entire contents of which are incorporated by reference herein.

### BACKGROUND

The present disclosure relates to a technique to support document translation.

Various techniques for supporting document translation are known. For example, a first technique is known that includes checking “content of document expressed in a second language” created by a user, on the basis of a “word list obtained through analysis of content of document expressed in a first language to be referred to”, thereby detecting a portion left untranslated, word by word. In addition, a second technique to match translated sentences with the layout of the original document, without awkwardness, is known.

### SUMMARY

The disclosure proposes further improvement of the foregoing techniques.

In an aspect, the disclosure provides a translation support device including a storage device and a control device. The storage device stores therein an original document file in which original document data is recorded, and a translated document file in which translated document data, representing a translated document translated from an original document represented by the original document data, is recorded. The control device includes a processor, and acts as a detector and a generator, when the processor executes a control program. The detector detects, through comparison between the original document file and the translated document file, an identical portion contained in common in both of the files, as an untranslated portion. The generator generates untranslated portion information indicating the untranslated portion.

### BRIEF DESCRIPTION OF THE DRAWINGS

FIG. 1 is a block diagram showing an internal configuration of an image forming apparatus according to a first embodiment;

FIG. 2 is a schematic drawing showing an example of an original document;

FIG. 3 is a schematic drawing showing an example of a translated document;

FIG. 4 is a schematic drawing showing an example of untranslated portions;

FIG. 5 is a schematic drawing showing an example of a first document representing untranslated portion information;

FIG. 6 is a schematic drawing showing an example of a second document representing the untranslated portion information;

FIG. 7 is a schematic drawing showing an example of an operation screen;

FIG. 8 is a schematic drawing showing another example of the operation screen;

FIG. 9 is a flowchart showing a process to provide untranslated portion information;

FIG. 10 is a schematic drawing showing still another example of the operation screen;

FIG. 11 is a schematic drawing showing still another example of the operation screen;

FIG. 12 is a block diagram showing an internal configuration of an image forming apparatus according to a second embodiment; and

FIG. 13 is a schematic drawing showing still another example of the operation screen.

### DETAILED DESCRIPTION

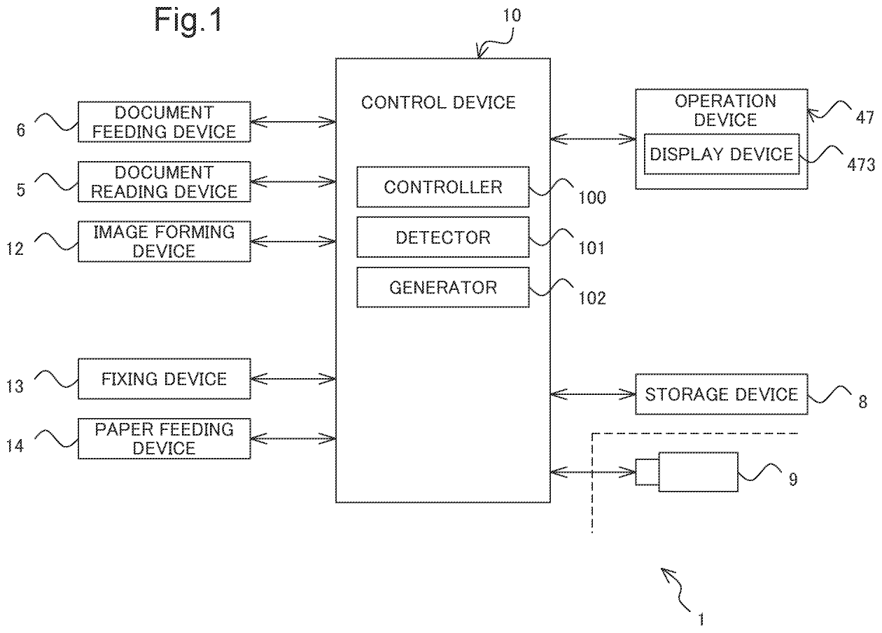

Hereafter, a translation support device and an image forming apparatus according to some embodiments of the disclosure will be described, with reference to the drawings. FIG. 1 is a functional block diagram schematically showing an essential internal configuration of the image forming apparatus 1 according to a first embodiment of the disclosure. The image forming apparatus 1 is a multifunction peripheral having a plurality of functions, such as copying, printing, scanning, and facsimile transmission.

The image forming apparatus 1 includes a control device 10, a document feeding device 6, a document reading device 5, an image forming device 12, a fixing device 13, a paper feeding device 14, an operation device 47, and a storage device 8. To the image forming apparatus 1, a universal serial bus (USB) memory 9, which is an external memory, can be detachably connected. The image forming apparatus 1 exemplifies the translation support device in the disclosure.

The document feeding device 6 is openably connected to the upper face of the document reading device 5, for example via a hinge. The document feeding device 6 serves as a document retention cover, when the document reading device 5 reads a source document placed on the platen glass. The document feeding device 6 is what is known as an automatic document feeder (ADF). The document feeding device 6 includes a document tray, and delivers the source documents placed thereon one by one, to the document reading device 5.

To perform the document reading operation, the image forming apparatus 1 operates as follows. The document reading device 5 optically reads the image on the source document delivered from the document feeding device 6 to the document reading device 5, or placed on the platen glass, and generates image data. The image data generated by the document reading device 5 is stored, for example, in an image memory.

To perform the image forming operation, the image forming apparatus 1 operates as follows. The image forming device 12 forms a toner image on a recording sheet, exemplifying the recording medium in the disclosure, and delivered from the paper feeding device 14, on the basis of the image data generated through the document reading operation, the image data stored in the image memory, or image data received from a computer connected via a network.

The fixing device 13 heats and presses the recording sheet on which the toner image has been formed by the image forming device 12, to thereby fix the toner image on the recording sheet. The recording sheet that has undergone the fixing process is delivered to an output tray. The paper feeding device 14 includes a paper cassette.

The operation device 47 receives instructions from the user to execute the functions and operations that the image forming apparatus 1 is configured to perform. The operation device 47 includes the display device 473 for displaying, for example, an operation guide for the user. The operation device 47 receives, through the touch panel provided on the display device 473, the user's instruction based on the touch operation performed by the user on the operation screen displayed on the display device 473.

The operation device 47 also receives the instruction from the user, inputted by pressing a physical key provided on the operation device 47.

The display device 473 includes, for example, a liquid crystal display (LCD). The display device 473 includes the touch panel. When the user touches a button or a key displayed on the screen, the touch panel detects the instruction corresponding to the touched position.

The storage device 8 is a large-capacity storage device such as a hard disk drive (HDD) and a solid-state drive (SSD). The storage device 25 contains various control programs

The control device 10 includes a processor, a random-access memory (RAM), a read-only memory (ROM), and an exclusive hardware circuit. The processor is, for example, a central processing unit (CPU), an application specific integrated circuit (ASIC), or a micro processing unit (MPU).

The control device 10 acts as a controller 100, a detector 101, and a generator 102, when the processor operates according to a control program stored in the storage device 8. Here, the controller 100 and other components may be constituted in the form of a hardware circuit, instead of being realized by the operation of the control device 10 according to the control program. This also applies to other embodiments, unless otherwise specifically noted.

The controller 100 serves to control the overall operation of the image forming apparatus 1. The controller 100 is connected to the document feeding device 6, the document reading device 5, the image forming device 12, the fixing device 13, the paper feeding device 14, the operation device 47, the storage device 8, and the USB memory 9, and controls the operation of the mentioned components. For example, the controller 100 controls the operation of the image forming device 12, so as to form the source image acquired through the reading operation of the document reading device 5, on the recording sheet exemplifying the recording medium in the disclosure.

The detector 101 detects, through comparison between an original document file in which original document data is recorded, and a translated document file in which translated document data, representing a translated document translated from an original document represented by the original document data, is recorded, with a known file comparison technique, the identical portion contained in common in both of the files, as an untranslated portion.

The generator 102 generates untranslated portion information to be provided to the user, indicating the untranslated portion detected by the detector 101.

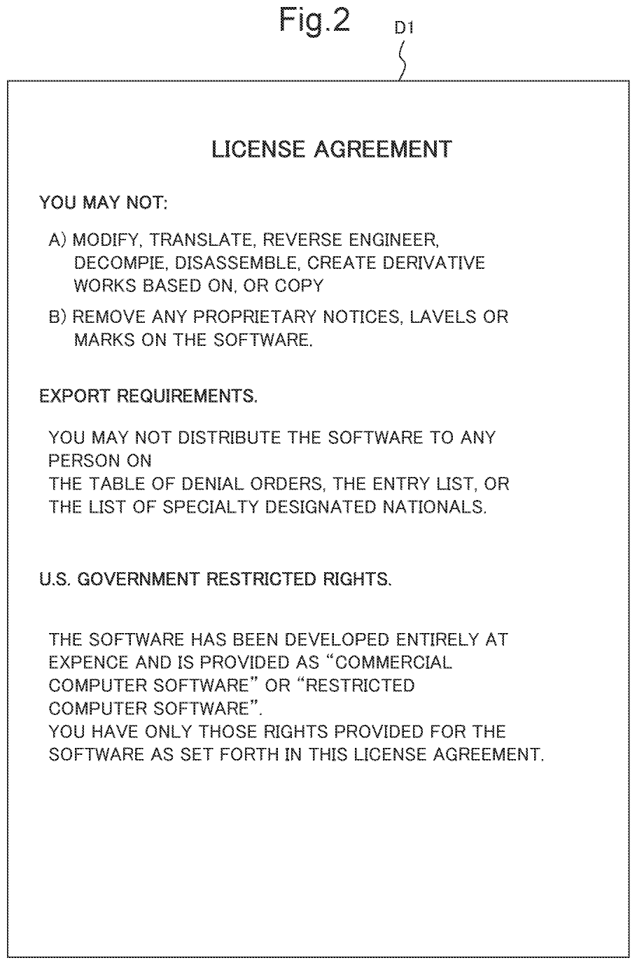

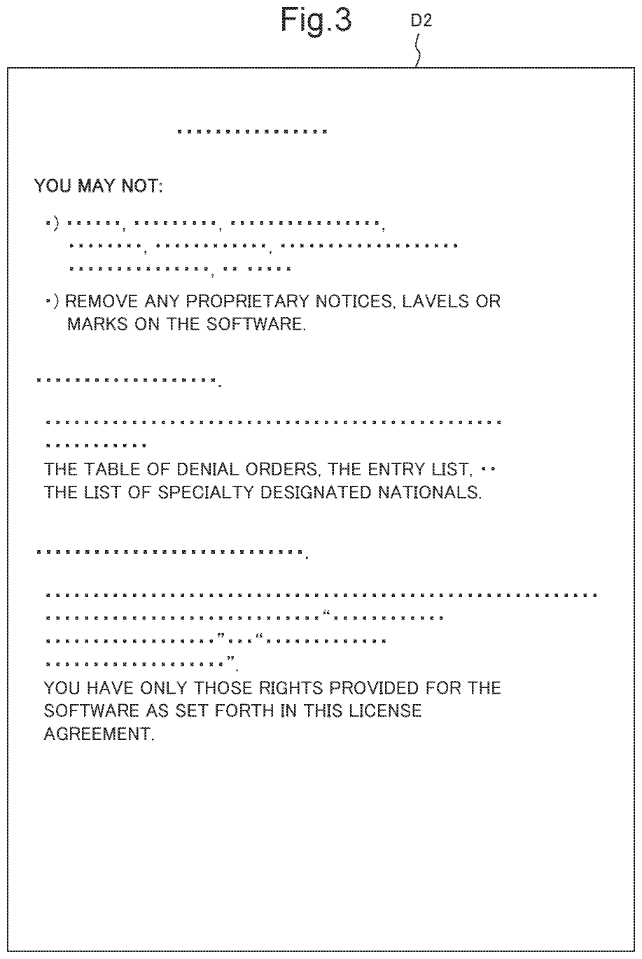

FIG. 2 illustrates an example of the original document D1. FIG. 3 illustrates an example of the translated document D2, translated from the original document shown in FIG. 2.

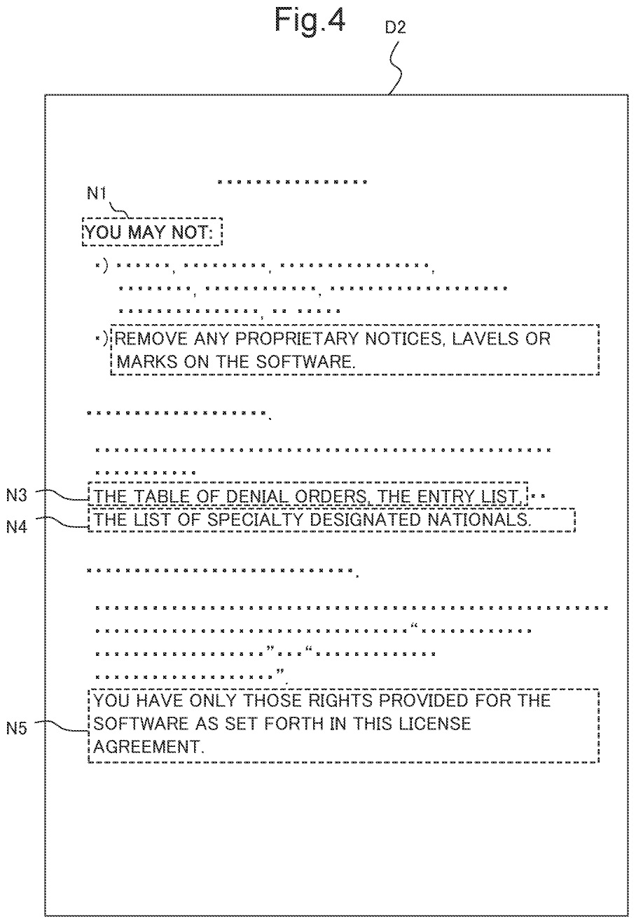

The detector 101 compares between the original document file, including original document data representing the original document D1 shown in FIG. 2, and the translated document file, including translated document data representing the translated document D2 shown in FIG. 3, thereby detecting the identical portions contained in common in both of the files, as untranslated portions N1 to N5 shown in FIG. 4.

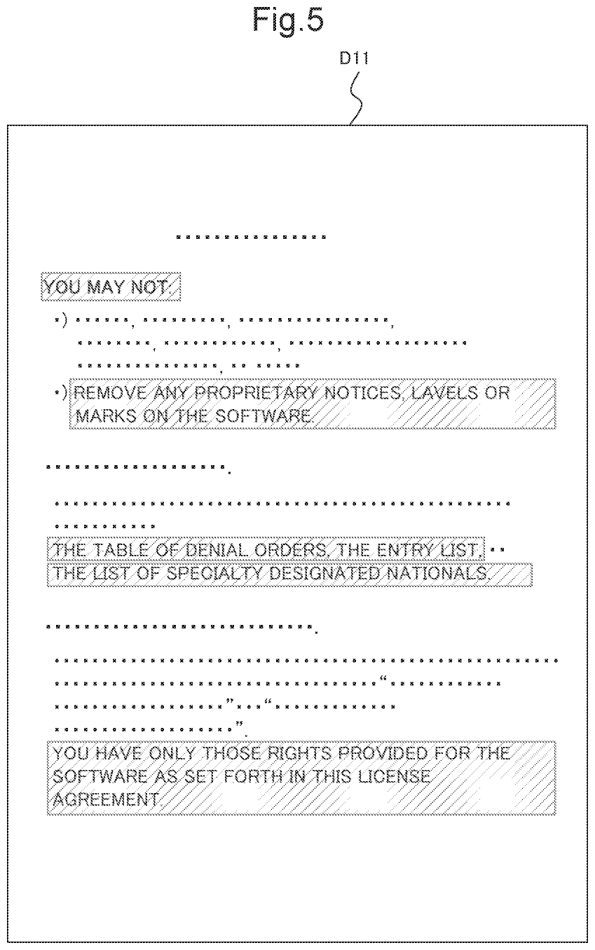

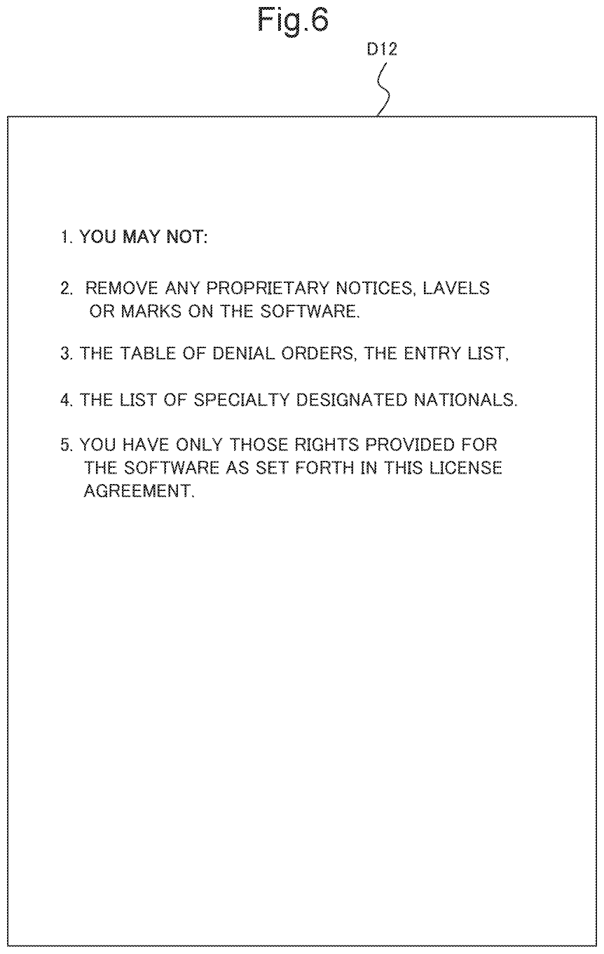

The generator 102 generates a first document D11 as the untranslated portion information indicating the untranslated portion detected by the detector 101, for example as shown in FIG. 5, by adding information that enables the user to distinguish between the translated portions and the untranslated portions N1 to N5 (e.g., by applying hatching) to the translated document D2 represented by the translated document data. Alternatively, the generator 102 may generate, for example as shown in FIG. 6, a second document D12 showing only the untranslated portions N1 to N5 as the untranslated portion information.

The controller 100 controls the image forming device 12, so as to print the first document D11 or the second document D12 on the recording sheet, on the basis of the document data representing the first document D11 or the second document D12 generated by the generator 102, to thereby create a printed material on which the first document D11 or the second document D12 is recorded. Alternatively, the controller 100 may save the document data, representing the first document D11 or the second document D12 generated by the generator 102, as one file in a predetermined storage device, for example the storage device 8 or USB memory 9.

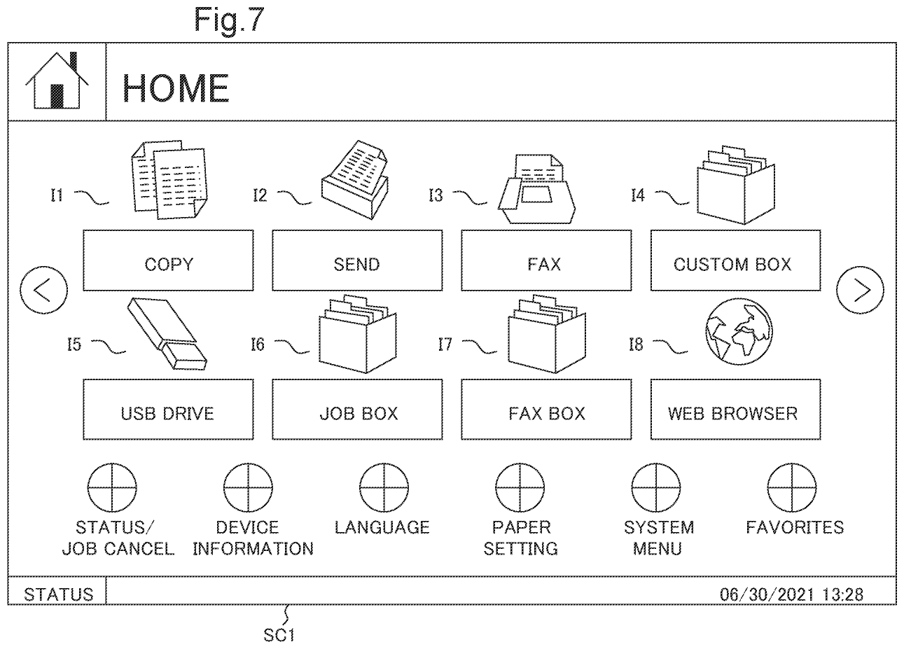

The controller 100 controls the display device 473, so as to display an operation screen SC1 shown in FIG. 7, as “home screen”. In the operation screen SC1, eight icons I1 to I8 are arranged, such as an icon I1 including a character string “Copy” and a pictogram representing the copying function, an icon I4 including a character string “Custom Box” and a pictogram representing the custom box, and an icon I5 including a character string “USB Drive” and a pictogram representing the USB memory.

The controller 100 executes control based on an instruction received by the operation device 47. For example, when the operation device 47 receives an instruction to the icon I1 through the touch panel, the controller 100 controls the display device 473 according to the instruction, so as to shift the operation screen displayed on the display device 473 from the home screen to a copy screen.

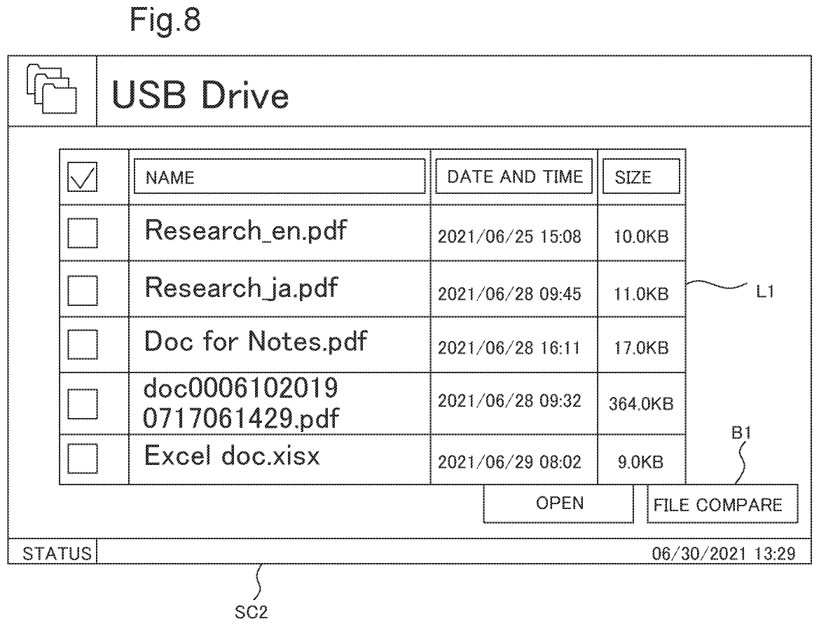

When the operation device 47 receives an instruction to the icon 15 through the touch panel, the controller 100 controls the display device 473, so as to display an operation screen SC2 including a file list L1 as shown in FIG. 8. The file list L1 includes the files stored in the USB memory 9 attached to the image forming apparatus 1. The controller 100 causes the display device 473 to display the file list L1 including the name of the file stored in the USB memory 9, the date and time that the file was stored, and the memory size of the file, and a checkbox for each of the files. The controller 100 also causes the display device 473 to display an operation button B1 marked as “File Compare”, on the operation screen SC2.

The operation device 47 receives, in accordance with the user's operation performed thereon, an instruction to select a comparison base file (original document file in which original document data is recorded), and a comparison target file (translated document file in which translated document data is recorded), from the file list L1.

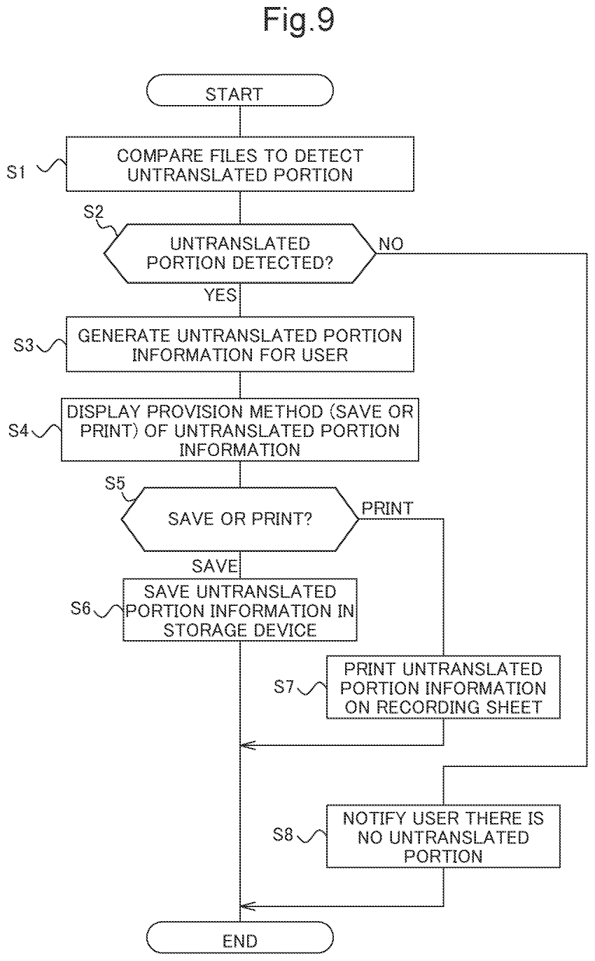

Referring now to a flowchart shown in FIG. 9, a process performed by the control device 10 to provide untranslated portion information will be described hereunder. This process is performed when the operation device 47 receives the mentioned selection instruction from the file list L1, according to the user's operation performed on the operation device 47, and then the operation button B1 is pressed by the user.

The detector 101 identifies the file selected first by the user through the operation device 47, as the comparison base file, and the file selected next by the user through the operation device 47 as the comparison target file. Then the detector 101 compares between these two files selected by the user, thereby detecting the identical portion contained in common in both of the files as the untranslated portion (step S1).

For example, when the user selects “Research_en.pdf” as the comparison base file, and “Research_ja.pdf” as the comparison target file, the detector 101 retrieves the files named as “Research_en.pdf” and “Research_ja.pdf” from the USB memory 9, and detects the untranslated portion through comparison of these files.

The controller 100 decides whether the detector 101 has detected the untranslated portion (step S2). Upon deciding that the untranslated portion has been detected (YES at step S2), the generator 102 generates the first document D11 or the second document D12, as untranslated portion information indicating the untranslated portion detected by the detector 101, to be provided to the user (step S3). The generator 102 generates the first document D11 or the second document D12, according to the user's instruction received in advance through the operation device 47.

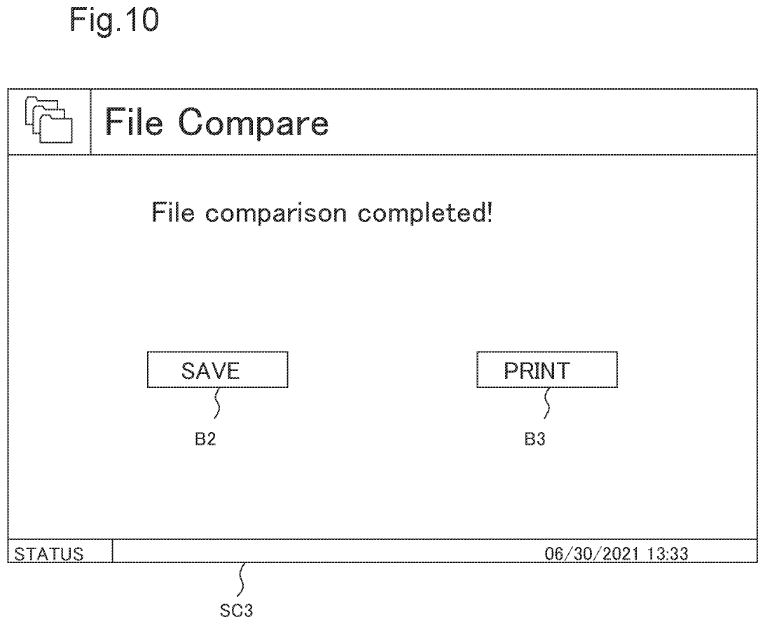

When the mentioned operations of the detector 101 and the generator 102 are completed, the controller 100 causes the display device 473 to display an operation screen SC3 shown in FIG. 10 (step S4). The operation screen SC3 serves to notify the user that the comparison of the files has been completed, and urge the user to select a provision method of the untranslated portion information (save or print). To be more detailed, the controller 100 causes the display device 473 to display an operation button B2 marked as “SAVE”, and an operation button B3 marked as “PRINT”, on the operation screen SC3.

The controller 100 decides which of “SAVE” and “PRINT” has been selected by the user through the operation device 47 (step S5). Upon deciding that the user has selected “SAVE” because the operation device 47 has received the instruction to select the operation button B2 (SAVE at step S5), the controller 100 stores the document data representing the first document D11 or the second document D12 generated by the generator 102, in the storage device as one file (step S6). After step S6, the controller 100 finishes the process of providing the untranslated portion information.

In contrast, in the case of deciding that the user has selected “PRINT” because the operation device 47 has received the instruction to select the operation button B3 (PRINT at step S5), the controller 100 controls the image forming device 12, so as to form the image based on the document data representing the first document D11 or the second document D12 generated by the generator 102, on the recording sheet (step S7). As result, a printed material having the first document D11 or the second document D12 recorded thereon is obtained.

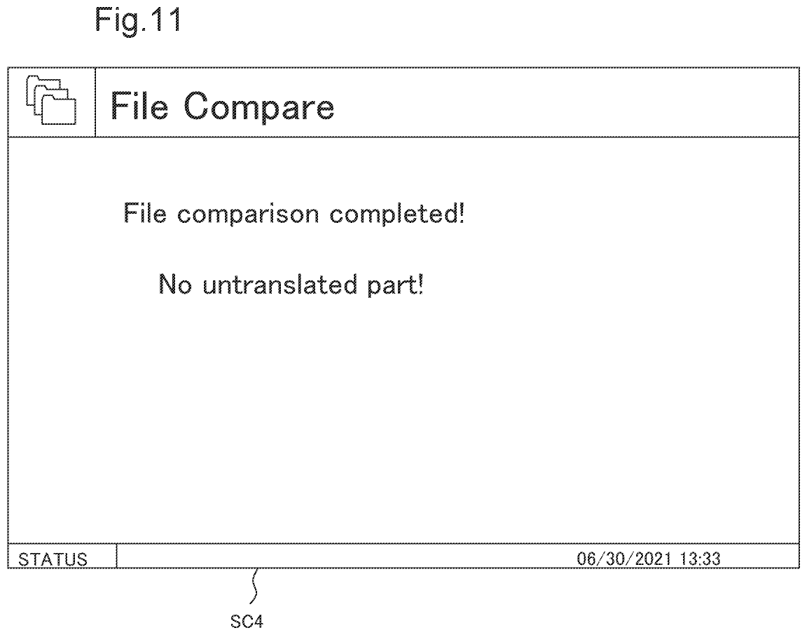

Upon deciding that the detector 101 has not detected the untranslated portion (NO at step S2), the controller 100 causes the display device 473 to display an operation screen SC4 shown in FIG. 11 (step S8). The operation screen SC4 serves to notify the user that there is no untranslated portion in the translated document. After step S8, the controller 100 finishes the process of providing the untranslated portion information.

Now, the information technology (IT) has recently made a significant progress, and the quality of translation tools has been largely improved. Yet, there are cases where a part of the original document to be translated remains untranslated from the original language. Naturally, though, this also applies to the case of human translation.

When the document size is small, the untranslated portion can be visually found out, rather easily. However, when the document size is large, such a work is troublesome. Besides, when an untranslated portion is discovered after the document translated from the original document is printed, the printed material turns into waste.

The aforementioned first technique includes creating the list of words contained in the original document to be translated, and detecting the untranslated word on the basis of the word list. However, the word list has to be created first, to detect the untranslated word, and therefore the process is inefficient. The second known technique, applicable to translated sentences, is not designed to detect the untranslated portion.

With the arrangement according to the first embodiment, in contrast, the untranslated portion can be detected through the comparison between the files, which is more efficient than the foregoing first and second techniques. In addition, the arrangement according to the first embodiment eliminates, unlike the first technique, the need to create the word list to detect the untranslated portion.

Further, the user can confirm the untranslated portion remaining in the translated document D2, in view of the printed material on which the first document D11 or the second document D12 is recorded. In addition, when the document data representing the first document D11 or the second document D12 is stored as one file, the user can confirm the untranslated portion remaining in the translated document D2, for example by using a PC, in view of the first document D11 or the second document D12 displayed on the screen. Therefore, the translated document D2 containing the untranslated portion can be prevented from being printed on a large number of recording sheets, and consequently mass production of useless printed materials can be easily prevented.

Here, there may be cases where the original document D1 and the translated document D2 are printed on the recording sheet. In a second embodiment, therefore, a scanning function is employed, to detect the untranslated portion by reading these documents with the scanning function.

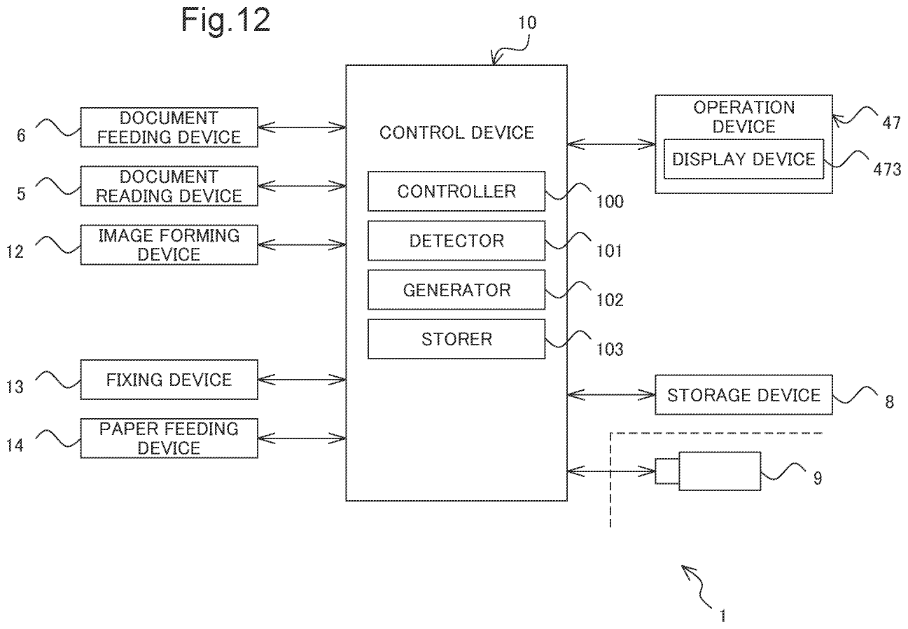

FIG. 12 is a functional block diagram showing an internal configuration of the image forming apparatus 1 according to the second embodiment of the disclosure. The image forming apparatus 1 according to the second embodiment is different from the image forming apparatus 1 according to the first embodiment shown in FIG. 1, in that the control device 10 includes a storer 103.

The control device 10 further acts as a storer 103, when the processor operates according to the control program stored in the storage device 8. Here, the storer 103 may be constituted in the form of a hardware circuit, instead of being realized by the operation of the control device 10 according to the control program.

The storer 103 performs character recognition with respect to the image data acquired through the reading operation by the document reading device 5, and representing each of the documents to be compared with each other, using a known optical character recognition (OCR) technique. The storer 103 stores the character data (text data) acquired through the OCR process and representing each of the documents, in a predetermined storage device, for example in the custom box included in the storage device 8, as one file for each document.

The detector 101 compares between the files, stored in the storage device and representing the character data of the respective documents, as in the case of comparing the files stored in the USB memory 9, exemplifying the external memory, to thereby detect the untranslated portion.

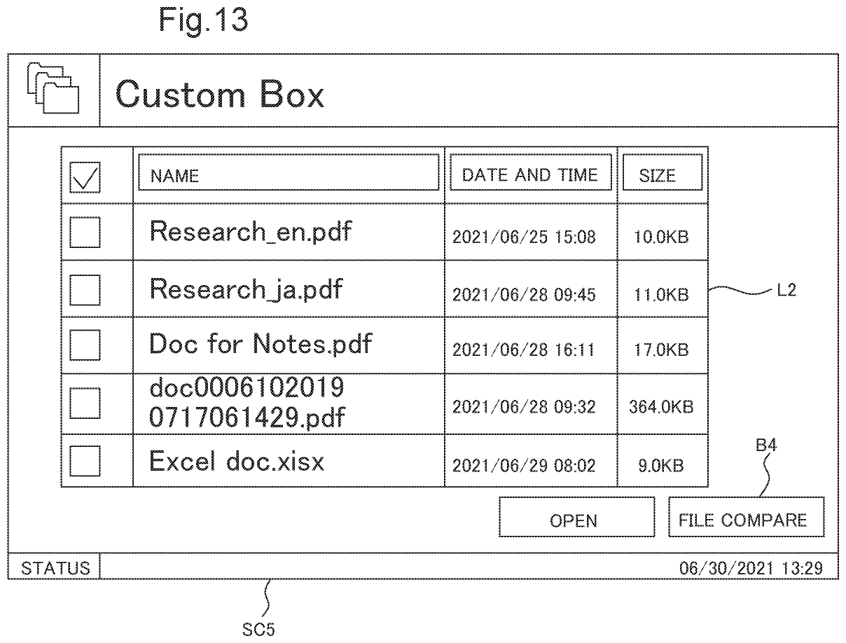

When the operation device 47 receives an instruction to the icon I4 through the operation screen SC1 of the home screen shown in FIG. 7, the controller 100 controls the display device 473, so as to display an operation screen SC5 including a file list L2 as shown in FIG. 13. The file list L2 includes the files stored in the custom box included in the storage device 8. The controller 100 causes the display device 473 to display the file list L2 including the name of the file stored in the custom box, the date and time that the file was stored, and the memory size of the file, and a checkbox for each of the files. The controller 100 also causes the display device 473 to display, as in the operation screen SC2 shown in FIG. 8, an operation button B4 marked as “File Compare” on the operation screen SC5.

The operation device 47 receives, in accordance with the user's operation performed thereon, the instruction to select the comparison base file (original document file in which original document data is recorded), and the comparison target file (translated document file in which translated document data is recorded), from the file list L2.

The arrangement according to the second embodiment enables the untranslated portion contained in the translated document to be detected, also with respect to the original document and the translated document each printed on the recording sheet, thereby further improving the user-friendliness.

Now, in the case of creating a translated document by translating an original document written in English into Japanese, an English word or character in the original document may be intentionally left as it is. In other words, there may be cases where the remaining English word or character should not be regarded as the untranslated portion.

As another embodiment, therefore, in the case where the identical portion contained in common in both of the original document file and the translated document file is smaller than a unit that constitutes a word, from the viewpoint of the document structure, the detector 101 keeps from detecting such identical portion as the untranslated portion.

Further, the original documents written in English may often contain a portion written in another language. For example, a Japanese or French word may be partly contained in the document written in English. In the case of creating a translated document by translating such an original document into Japanese, the Japanese word or the French word contained in the original document may be left as it is. In such a case, it is undesirable to detect the identical portion contained in common in both of the files, as the untranslated portion.

Accordingly, as still another embodiment, the detector 101 acquires the name of the translated document file, and keeps from detecting, on the basis of the predetermined language code included in the file name, the portion written in the language indicated by the language code, as the untranslated portion.

In the case where the language code of Japanese is designated in advance as “jp”, and the file name of a translated document file, in which a document translated into Japanese is recorded, is registered as “Research_jp.pdf” by the user, the detector 101 recognizes that the translated document stored in the translated document file is written in Japanese.

The detector 101 also acquires the name of the original document file, and keeps from detecting, on the basis of the predetermined language code included in the file name, the portion written in a language other than the language indicated by the language code, as the untranslated portion.

In the case where the language code of English is designated in advance as “en”, and the file name of an original document file, in which a document written in English is recorded, is registered as “Research_en.pdf” by the user, the detector 101 recognizes that the original document stored in the original document file is written in English.

The disclosure may be modified in various manners, without limitation to the configuration according to the foregoing embodiments. Although the translation support device according to the disclosure is exemplified by the multifunction peripheral in the foregoing embodiment, the disclosure may be applied to different types of electronic devices.

The configurations and processings according to the foregoing embodiment, described with reference to FIG. 1 to FIG. 13, are merely exemplary and in no way intended to limit the disclosure to those configurations and processings.

While the present disclosure has been described in detail with reference to the embodiments thereof, it would be apparent to those skilled in the art the various changes and modifications may be made therein within the scope defined by the appended claims.

What is claimed is:

1. A translation support device comprising:
a storage device storing therein an original document file in which original document data is recorded, and a translated document file in which translated document data, representing a translated document translated from an original document represented by the original document data, is recorded; and
a control device including a processor, and configured to act, when the processor executes a control program, as:
a detector that detects, through comparison between the original document file and the translated document file, an identical portion contained in common in both of the files, as an untranslated portion; and
a generator that generates untranslated portion information indicating the untranslated portion.

2. The translation support device according to claim 1,
wherein the detector keeps from detecting as the untranslated portion, a portion written in a language indicated by a language code included in a name of the translated document file.

3. The translation support device according to claim 1,
wherein the detector keeps from detecting as the untranslated portion, a portion written in a language other than a language indicated by a language code included in a name of the original document file.

4. The translation support device according to claim 1,
Wherein, when the identical portion is smaller than a unit that constitutes a word, from a viewpoint of a document structure, the detector keeps from detecting the identical portion as the untranslated portion.

5. The translation support device according to claim 1, further comprising a document reading device that reads an image of a source document,
wherein the control device further acts as a storer that executes a character recognition process with respect to image data acquired through a reading operation by the document reading device, and stores document data acquired through the character recognition process in the storage device, as one of the original document file and the translated document file.

6. The translation support device according to claim 1,
wherein the generator generates, as the untranslated portion information, first document data representing a first document, in which information that enables distinction between a translated portion and the untranslated portion is added to the translated document represented by the translated document data.

7. The translation support device according to claim 1,
wherein the generator generates, as the untranslated portion information, second document data representing a second document including only the untranslated portion.

8. The translation support device according to claim 1, further comprising an operation device to which an instruction of a user is inputted,
wherein the detector identifies a file, a selection instruction of which has been received first by the operation device, as the original document file, and a file, a selection instruction of which has been received next by the operation device, as the translated document file.

9. An image forming apparatus comprising:
the translation support device according to claim 6; and
an image forming device that forms an image on a recording medium,
wherein the control device further acts as a controller that causes the image forming device to form the first document represented by the first document data, on the recording medium.

10. An image forming apparatus comprising:
the translation support device according to claim 7; and
an image forming device that forms an image on a recording medium,
wherein the control device further acts as a controller that causes the image forming device to form the second document represented by the second document data, on the recording medium.
